(19) United States
(12) Patent Application Publication
(10) Pub. No.: US 2018/0250815 A1
(43) Pub. Date: Sep. 6, 2018

(54) ROBOT ANIMATION LAYERING

(71) Applicant: Anki, Inc., San Francisco, CA (US)

(72) Inventors: Andrew Neil Stein, San Francisco, CA (US); Kevin Yoon, Oakland, CA (US); Richard Chaussee, Walnut Creek, CA (US); Lee Crippen, Berkeley, CA (US); Mark Wesley, Novato, CA (US); Michelle Sintov, San Francisco, CA (US); Hanns Tappeiner, San Francisco, CA (US)

(21) Appl. No.: 15/633,652

(22) Filed: Jun. 26, 2017

Related U.S. Application Data
(60) Provisional application No. 62/466,801, filed on Mar. 3, 2017.

(51) Int. Cl. B25J 9/16; B25J 11/00

(52) U.S. Cl. CPC B25J 9/1658; G05B 2219/40392; B25J 11/001

(57) ABSTRACT

Exemplary methods, apparatuses, and systems receive first and second sets of command tracks, each set including one or more command tracks and each command track directed to control a component of a robot. In response to detecting that a first command track within the first set is directed to control a first component of the robot to perform a first action and a second command track within the second set is directed to control the first component of the robot to perform a second action, the first and second command tracks are merged into a composite command track. The composite command track is executed, causing the first component of the robot to perform the first action while performing the second action.

### CROSS-REFERENCE TO RELATED APPLICATIONS

This application claims the benefit of U.S. Provisional Application No. 62/466,801, filed Mar. 3, 2017, which is hereby incorporated by reference.

### FIELD OF THE INVENTION

The various embodiments described in this document relate to creating, managing, prioritizing, and executing animation control commands for a robot.

### BACKGROUND OF THE INVENTION

A robot that exhibits life-like behaviors may increase user engagement with the robot. For example, small animated movements, noises, and simulated facial changes in between and in addition to specific, purposeful robotic animations creates a sense of a life-like quality of a robot.

### BRIEF DESCRIPTION OF THE DRAWINGS

The present embodiments are illustrated by way of example and not limitation in the figures of the accompanying drawings, in which like references indicate similar elements, and in which:

FIG. 1 illustrates an exemplary robot that executes animation control commands;

FIG. 2 illustrates, in block diagram form, components of a system to create, manage, prioritize, and execute animation control commands;

FIG. 3 is a flow chart illustrating an exemplary method of managing, prioritizing, and executing animation control commands;

FIG. 4 is a flow chart illustrating another exemplary method of managing, prioritizing, and executing animation control commands;

FIGS. 5-10 illustrate an exemplary sequence of frames to animate a display object using an animation command track;

FIGS. 11-14 illustrate an exemplary sequence of frames to animate a display object using a composite animation command track; and

FIG. 15 illustrates an exemplary interactive cube that may trigger one or more animation control commands.

### DETAILED DESCRIPTION

This document describes embodiments that relate to a robot animation control system receiving animation controls in the form of multiple sets of command tracks to control physical components of the robot. For example, one set of command tracks may be the input from a user interface, game engine, set of software development kit (SDK) instructions, etc. and another set of command tracks may be input from a procedural animation control system to simulate life-like behaviors. Each command track is directed to control a physical component of a robot. The robot animation control system determines if any command track is to be combined with another command track or disregarded. For example, in response to detecting that a first command track within a first set is directed to control a first component of the robot to perform a first action and a second command track within the second set is directed to control the first component of the robot to perform a second action, the robot animation control system merges the first and second command tracks into a composite command track to control the first component of the robot. When the composite command track is executed, the first component of the robot performs the first action while performing the second action. As a result, multiple, possibly-conflicting sources are able to animate or otherwise control components of the robot simultaneously. The sources do not require awareness of one another or coordination with one another to generate a single, consistent, safe set of command tracks for execution by the robot. Life-like behaviors can be simulated both in between and in combination with an asynchronous command stream so that authors of animations do not need to also include the life-like behaviors in their command tracks. Additionally, embodiments can avoid the need for hard-coded solutions to every permutation of command combinations.

In one embodiment, the robot animation control system merges command tracks into a composite command track further in response to determining one of the command tracks is not in conflict with one another or with a current state of the robot. When a command track conflicts with another command track or with a state of the robot, the robot animation control system disregards or otherwise omits a conflicting command track. The determination to disregard or execute a command track may depend upon relative priority between the command track and the conflicting command track/state. In response to detecting a conflict between two sets of command tracks or between a single set of command tracks and a state of the robot, the robot animation control system determines relative priority of the command track(s) and/or state and disregards the lower priority command track/state. For example, a command to move the robot's arms during a current state of the robot holding an object using its arms may result in a conflict. In response to such a conflict, the robot animation control system disregards the command track to move the robot's arms when continuing to hold the object is a higher priority. The robot animation control system, however, may execute other command tracks in the set. As a result, the robot still executes an animation using other components but disregards the portion of an animation that is of lower priority than a conflicting command or state for a particular component.

Additional details of these and other embodiments are set forth in this document with reference to the drawings.

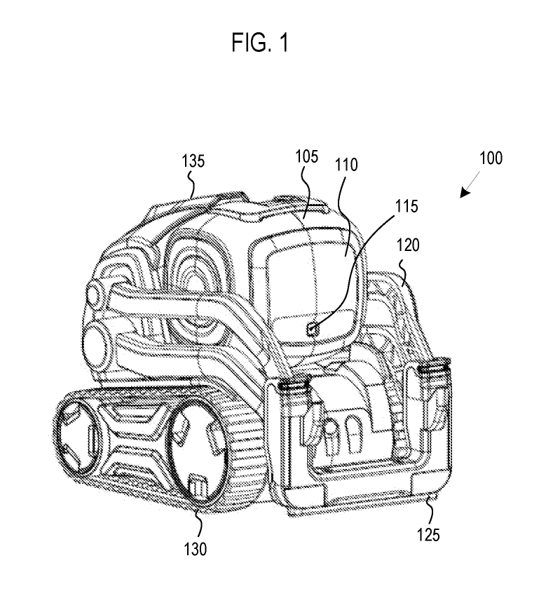

FIG. 1 illustrates exemplary robot 100 that executes animation control commands. Robot 100 includes several controllable components, including head 105, electronic display 110, camera 115, arms 120, lift attachment 125, wheels/tracks 130, and light(s) 135. For example, embodiments control movement of head 105, arms 120, and wheels/tracks 130 using one or more motors or other actuators.

Robot 100 also includes electronic display 110. For example, electronic display 110 may be a liquid crystal display (LCD), light emitting diode (LED) display, organic LED (OLED) display, plasma display panel (PDP) or other type of display. In one embodiment, electronic display 110 is monochromatic. Additionally, embodiments control visual outputs via light(s) 135.

Robot 100 may include additional components that are not illustrated, such as sensor(s), microphone(s), and speaker(s). Exemplary sensors include one or more proximity sensors (e.g., cliff sensors), a motion sensor and/or accelerometer, touch sensor(s), etc. Camera 115, sensor(s), and/or microphone(s) provide inputs for animation control commands for robot 100. Robot 100 executes audio outputs using speakers.

In one embodiment, robot 100 controls one or more external accessories or interactive objects. While not physically a part of or permanently affixed to robot 100, external accessories or interactive objects may be controlled in a manner similar to the components described above.

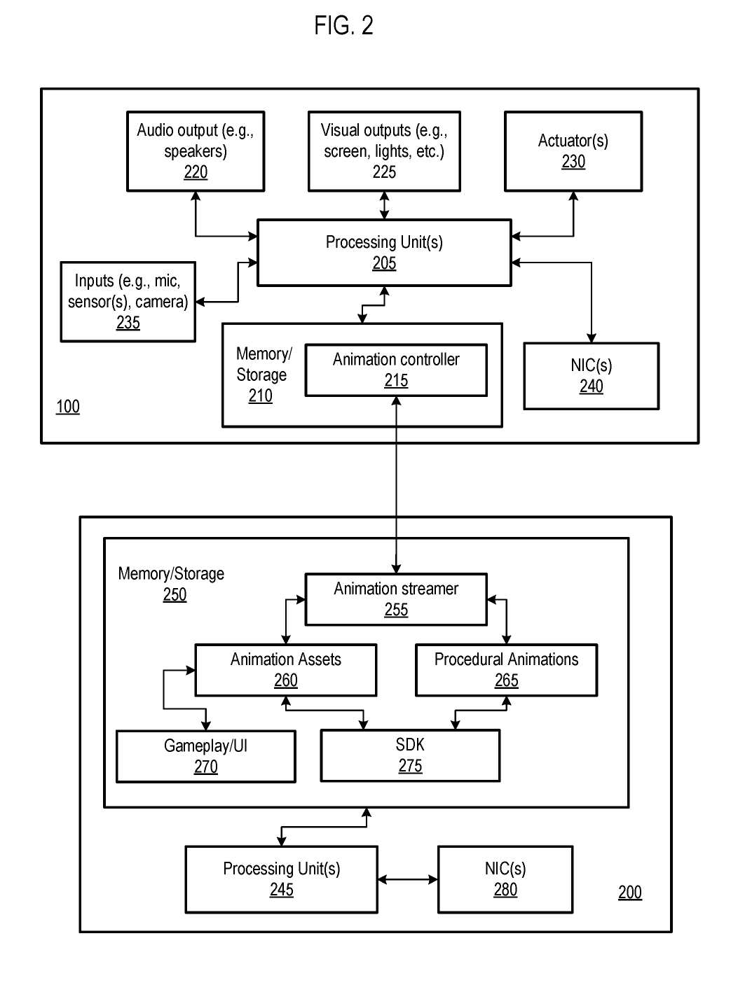

While illustrated in particular quantity and positions, components of robot 100 may be located on different portions of robot 100 and in greater or fewer quantities. Components of robot 100 are discussed in further detail with reference to FIG. 2. Additionally, robot 100 can take any suitable form, and may simulate the appearance of a human, animal, character, or other living entity. Representative examples of robot 100 include toys, entertainment devices, animatronic puppets, and/or the like.

FIG. 2 illustrates, in block diagram form, components of a system to create, manage, prioritize, and execute animation control commands. The exemplary system includes robot 100 and user device 200. For example, user device 200 may include a computer, mobile device, and/or other consumer electronics device that has the components described in this document.

Robot 100 includes one or more processing unit(s) 205. Processing unit(s) 205 may include a central processing unit (CPU), graphics processing unit (GPU), microprocessor, microcontroller, system on a chip, and/or another integrated circuit.

Robot 100 also includes memory/storage 210. In one embodiment, memory/storage 210 is one or more of volatile and non-volatile memories, such as Random Access Memory (RAM), Read Only Memory (ROM), a solid-state disk (SSD), Flash, Phase Change Memory (PCM), or other types of data storage. Memory/storage 210 stores data, metadata, and/or programs for execution by the processing unit(s) 205. For example, memory/storage 210 stores program module(s) such as animation controller 215.

Animation controller 215 converts command tracks into signals to control components of robot 100. For example, animation controller 215 may convert a command track for changing tilt of head 105 into an output signal to an actuator 230 such that the signal controls the speed and length of time the actuator moves to change the tilt of head 105. In one embodiment, animation controller 215 provides an interface for and controls output to electronic display 110 (e.g., serving as a display driver). In an alternate embodiment, or additionally, processing unit(s) 205 provide a hardware interface to one or more of the components of robot 100.

Robot 100 also includes components for controlling outputs, such as audio output 220, visual output 225, and actuator(s) 230. Audio output 220 includes a speaker for generating robot vocalizations and other sounds. Visual output 225 includes electronic display 110, lights 135, etc. In one embodiment, lights 135 include light emitting diodes (LEDs) or other devices that emit light in the visible spectrum of light and/or light outside of the visible spectrum (e.g., infrared).

Robot 100 includes components for controlling inputs 235. Input components 235 include one or more microphones, sensors, and/or camera 115. In one embodiment, command tracks activate one or more input components 235. Exemplary sensors include distance sensors (e.g., an infrared sensor), an accelerometer or motion/vibration sensor, touch sensor (such as a capacitive touch sensor), etc. Input detected by an input component 235 may include an image by camera 115 (e.g., for face detection), a sound by microphone(s) (e.g., for a voice command or sound localization), distance to an object (e.g., cliff sensor or other object sensor), handling of robot 100 (e.g., via touch, vibration, or movement), or position of the robot relative to the ground (e.g., using an accelerometer and/or gyroscope).

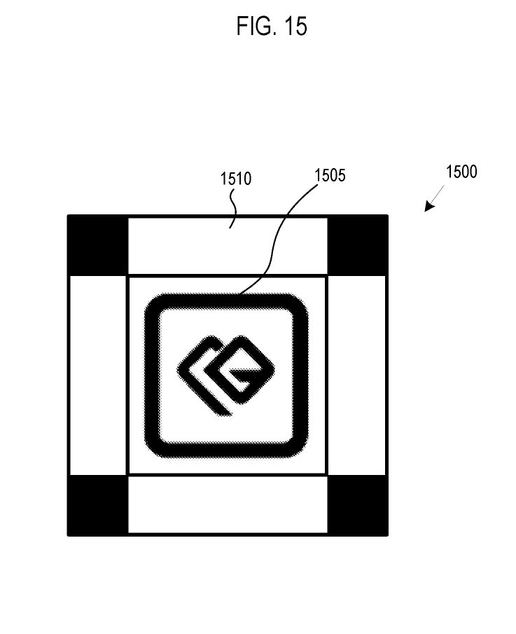

Robot 100 is further illustrated as including one or more network interface controllers (NICs) 240. Exemplary NIC(s) 240 include wireless interfaces, such as WiFi and Bluetooth interfaces. NIC(s) 240 enable robot 100 to communicate, e.g., wirelessly with user device 200 and/or other interactive objects (such as interactive cube described with reference to FIG. 15).

User device 200 includes one or more processing unit(s) 245. Processing unit(s) 245 may include a central processing unit (CPU), graphics processing unit (GPU), microprocessor, microcontroller, system on a chip, and/or another integrated circuit.

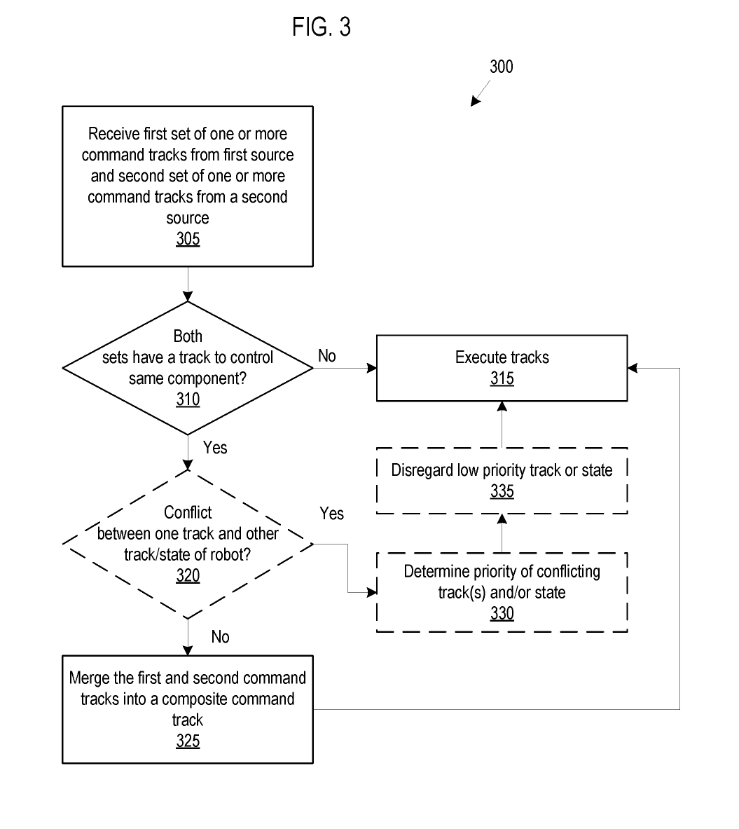

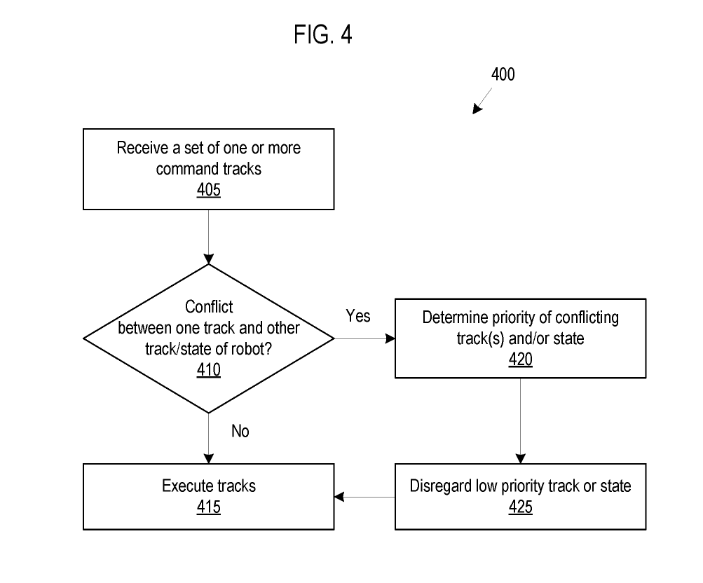

User device 200 also includes memory/storage 250. In one embodiment, memory/storage 250 is one or more of volatile and non-volatile memories, such as Random Access Memory (RAM), Read Only Memory (ROM), a solid-state disk (SSD), Flash, Phase Change Memory (PCM), or other types of data storage. Memory/storage 250 stores data, metadata, and/or programs for execution by the processing unit(s) 245. For example, memory/storage 250 stores program module(s) such as animation streamer module 255, animation assets module 260, procedural animations module 265, gameplay/UI module 270, and SDK module 275. The details of animation streamer module 255, animation assets module 260, procedural animations module 265, gameplay/UI module 270, and SDK module 275 are described with reference to FIGS. 3-4.

User device 200 is further illustrated as including one or more network interface controllers (NICs) 280. Exemplary NIC(s) 280 include wireless interfaces, such as WiFi and Bluetooth interfaces. NIC(s) 280 enable user device 200 to communicate, e.g., wirelessly with user robot 100 and/or other interactive objects. For example, communication between animation streamer module 255 and animation controller 215 may be transmitted via NIC(s) 280 and NIC(s) 240. In one embodiment, animation streamer module 255, animation assets module 260, and/or procedural animations module 265 are included within memory/storage 210 of robot 100. In such an embodiment, communication between animation streamer module 255 and animation controller 215 may be performed, e.g., via shared memory within memory/storage 210.

FIG. 3 is a flow chart illustrating exemplary method 300 of managing, prioritizing, and executing animation control commands. In one embodiment, animation control commands include sets of command tracks or keyframes. Each command track within a set includes indications as to which component of robot 100 is to be controlled and how to control it. The following is one example of a command track, represented in JSON (JavaScript Object Notation) format:

{

“angle_deg”: 45,
“angleVariability_deg”: 0,
“triggerTime_ms”: 0,
“Name”: “HeadAngleKeyframe”,
“durationTime_ms”: 1650

}

This exemplary command track controls the angular position of the head 105. The first line indicates the absolute angular position of head 105, the second line specifies an amount of random variation by which to adjust that absolute position so as to introduce variability in the appearance of the animation (chosen at the time the animation is actually played), the third line specifies the time at which to execute this movement of head 105, the fourth line indicates that this command track is to control the angle of head 105, and the fifth line indicates the amount of time the motion is to take from start to completion. For example, this command track will move head 105 for 1,650 milliseconds from its current position to 45°. Robot 100 interpolates the movement from the current position to 45°. Thus, the start position of the component does not have to be specified in the command track.

A set of one or more command tracks defines an animation for robot 100. As used in this document, an animation controls one or more physical components of robot 100. For example, an animation may include multiple command tracks causing robot 100 to move head 105 to an upward facing angle, arms 120 up and down, wheels/tracks 130 to propel robot 100 in a circle, change an output to electronic display 110 to show eyes or a facial expression simulating a happy expression, change the intensity or color of lights 135, and/or play one more audio tracks simulating happy sounds or phrases. As another example, an animation may include movements, sounds, and/or display output to create life-like behaviors of robot 100. This may include periodic blinking or other movement of eyes on electronic display 110, sounds or movements to get the attention of a user, setting a tone of audio output or a speed of movements of components to simulate a mood, etc. These animations result in robot 100 appearing as a live character with a simulated personality, behavioral intelligence, anthropomorphic or zoomorphic traits, and/or other life-like qualities.

In one embodiment, an audio command track controls timing of animations. For example, each set of command tracks includes an audio command track. Even if there is no audio output during a portion or all of an animation, the set of command tracks includes silence or an indication of silence in the audio command track. Each audio command track or audio packet within an audio command track has a uniform rate or cadence. For example, an audio sample playback rate may be set to a fixed value and thus the duration of each audio sample is the same length. Thus, the audio command tracks provide a consistent means of timing for synchronizing the execution of other command tracks. For example, the trigger time referenced in the exemplary command track above may be relative to the start and playback of the audio command track.

In one embodiment, event tracks provide feedback from robot 100 to user device 200. For example, event tracks sent by robot 100 may indicate to user device 200 the success or failure of execution of event tracks sent by user device 200, a current state of robot 100, etc.

At block 305, animation streamer module 255 receives a first set of one or more command tracks from first source and second set of one or more command tracks from a second source. For example, animation assets module 260 may issue the first set of one or more command tracks and procedural animations module 265 may issue the second set of one or more command tracks.

In one embodiment, animation assets module 260 issues command tracks authored, e.g., by an animator to control one or more components of robot 100 in a specific manner. At least some command tracks from animation assets module 260 are not dependent upon run-time calculations and/or robot state information. For example, a command track to move head 105 to an angle of 45 degrees does not require run-time calculations or knowledge of the current position of head 105 to execute. In one embodiment, animation assets module 260 issues a high-level command that requires run-time calculations and/or robot state information. In such an embodiment, the high-level command is passed from animation assets module 260 to animation streamer module 255 and from animation streamer module 255 to procedural animations module 265 for processing. For example, an animator may author a high-level command for robot 100 to move to an interactive object. The path between robot 100 and the interactive object will not be known to the animator in advance, so animation assets module 260 cannot issue command tracks specifying time, direction, etc. for wheels/tracks 130. Animation streamer module 255 passes this high-level command to procedural animations module 265 to calculate the path and issue a set of specific command tracks according to the calculated path. Procedural animations module 265 uses robot state information (e.g., recognition of the interactive object in an image captured by camera 115) and calculates a path to the interactive object (e.g., based upon a relative position of the interactive object estimated based upon the image).

In one embodiment, in addition to generating command tracks calculated during run-time in response to high-level commands or other inputs, procedural animations module 265 issues command tracks executed periodically (e.g., eye blinks and other life-like behaviors).

The first set of command tracks may result from the input from a user interface (UI) or a game engine via gameplay/UI module 270 or as a set of SDK instructions from SDK 275. Sets of command tracks from gameplay/UI module 270 may result from a user selecting an animation for robot 100 to perform in a user interface. For example, the user may instruct robot 100 to drive to and lift an object (e.g., an interactive cube) identified by robot 100 using camera 115. Sets of command tracks from gameplay/UI module 270 may also include animations automated in response to gameplay interactions between the user, user device 200, and robot 100.

Sets of command tracks from SDK 275 may result from a user writing software to control the behavior of robot 100. For example, SDK 275 may allow a user to write a program in an object-oriented language, interpreted language, scripting language, or visual programming language. SDK 275 translates or interprets instructions as written in the programming language into animations that can be executed by animation streamer module 255 and animation controller 215. As a result, complicated animations and input triggers, such as those that use camera 115 to recognize a face or interactive object, can be made accessible to users without exposing extensive proprietary code or creating cumbersome libraries. For example, SDK 275 may provide translation interpretation for a block visual programming language (e.g., Scratch) for robot 100 to express an emotion, perform an action in response to detecting a face with camera 115, perform an action in response to detecting a smiling face with camera 115, perform an action in response to detecting a frowning face with camera 115, perform an action in response to detecting an interactive object (e.g., cube 1500) with camera 115, perform an action in response to detecting a signal from an interactive object that a user has interacted with the object, or execute another animation.

In one embodiment, SDK 275 translates instructions into bytes of code and transmits the bytes of code as a transport layer message to animation assets module 260 and/or procedural animations module 265 (e.g., SDK 275 may be run on a second user device and transmitted via a wired or wireless connection to user device 200). Animation assets module 260 and/or procedural animations module 265 receives the bytes of code, translates the bytes of code into one or more command tracks or keyframes, and passes or transmits the command tracks to animation streamer module 255.

The second set of command tracks from procedural animations module 265 may simulate life-like behaviors. For example, procedural animation module 265 may issue a set of command tracks that cause animated eyes on display 110 to periodically blink during and/or between animations generated by gameplay/UI module 270. Other examples of animations from procedural animation module 265 include moods that, e.g., control eye shape or facial expressions on display 110, tone of audio output, speed of movements, relative priority of command tracks, etc. In one embodiment, procedural animation module 265 issues a set of command tracks to indicate a problem with robot 100 (such as a need for repair). For example, the indication may include use of lights 135 to output a particular color/pattern or display 110 to distort the animated eyes or face of robot 100.

At block 310, animation streamer module 255 determines if both sets of command tracks include a command track to control the same component of robot 100. For example, both sets may include command tracks to control display 110 or both sets may include command tracks to control wheels/tracks 130. If the two sets of command tracks do not each have a command track to control the same component of robot 100, at block 315, animation streamer module 255 executes the sets of command tracks by transmitting (e.g., wirelessly) or passing (e.g., via shared memory) them to animation controller 215.

If both sets of command tracks include a track to control the same component of robot 100, at block 320, animation streamer module 255 optionally determines if there is a conflict between the two command tracks or between one of the command tracks and a current state of robot 100. For example, a command track to cause robot 100 to drive forward would be in conflict with a command track to cause robot 100 to drive backwards or with a state indicating robot 100 previously detected a cliff ahead. Additionally, a command track to cause robot 100 to quickly move arms 120 down would be in conflict with a state of robot 100 indicating that robot 100 is holding an interactive object with lift 125 connected to arms 120. As another example, a command track that is part of an animation to simulate a happy behavior may be in conflict with a current state of robot 100 indicating an unhappy mood.

In one embodiment, control of a component of robot 100 is divided into layers that can be separately composed/authored. Command tracks directed to different layers may not be in conflict with one another. For example, the position of animated eyes on display 110 may be one layer of the face component's command track, the shape of the eyes may be another layer, and the blinking of the eyes may be yet another layer. Continuing this example, one layer may make robot 100 simulate a happy face (“smiling eyes”) and a simultaneous turning command track may create a second layer to move the eyes to the left to “lead” in the direction of the turn. Animation streamer module 255 may combine these two layers into a happy face with eyes shifted left while robot 100 executes the turn. These layers can be temporary or persistent. Temporary layers, like a blink, affect the underlying animation for a limited time and then are removed. Persistent layers, like an eye dart, may move the eye to a new position and hold it there until the layer is removed, releasing the eye back to its original position. In another embodiment, animation streamer module 255 accesses a data structure containing conflicting and/or non-conflicting commands to determine whether or not a conflict is present.

At block 325, if there is no conflict or if block 320 is omitted from method 300, animation streamer module 255 merges the identified command tracks directed to control the same component of robot 100. In one embodiment, merging command tracks includes setting a control parameter (angle, trigger time, time of duration, etc.) to the result of a mathematical or logical operation performed on the values of the separate command tracks. For example, the composite command track may be a union of control parameters, such as the inclusion of each command track layer for a particular component. Once animation streamer module 255 creates the composite command track, method 300 proceeds to block 315 and executes the composite command track and any other command tracks in the first and second sets.

At block 330, if there is a conflict between command tracks, animation streamer module 255 determines a priority for each command track or the conflicting command track and state of robot 100. For example, animation streamer module 255 determines command track priority using a data structure mapping command tracks to priority values. In one embodiment, priority values are static. In another embodiment, priority values are dynamic and dependent upon, e.g., a current state of robot 100. For example, the data structure may map a command track to a first priority value when the state of robot 100 indicates a simulated happy mood and to a second priority value when the state of robot 100 indicates a simulated unhappy mood.

At block 335, animation streamer module 255 disregards or otherwise omits the command track or state having a lower priority value than the conflicting state or command track and method 300 proceeds to block 315 to execute any other command tracks in the first and second sets. For example, one command track might require the use of wheels/tracks 130 to move robot 100 to a particular position or pose. The priority value for that command track indicates that it not be overridden by another command track that moves wheels/tracks 130 for a less important animation that also moves lift 125 up and down. The command track to move lift 125 may be executed, but because the higher priority command locked use of wheels/tracks 130, only the lift 125 portion of the animation would play as the robot drove to the commanded pose.

In an embodiment in which a state is disregarded, the command track is performed despite the state of robot 100. For example, a current state of robot 100 may indicate that robot 100 is holding an interactive object up with lift 125. If a command track to lower lift 125 (and drop the interactive object) has a higher priority than the state, animation streamer module 255 will execute the command track and drop the object.

In one embodiment, portions of method 300 is performed in parallel for different command tracks. For example, the two sets of command tracks may include both a pair of command tracks merged into a composite command track and another a command track that has a conflict, resulting in the omitting of a command track.

FIG. 4 is a flow chart illustrating exemplary method 400 of managing, prioritizing, and executing animation control commands. While similar to method 300, method 400 emphasizes that animation streamer module 255 detects conflicts between a single set of command tracks and a state of robot 100 or between sets of command tracks that do not have tracks directed to controlling the same component.

At block 405, animation streamer module 255 receives a set of one or more command tracks from animation assets module 260 or procedural animations module 265. At block 410, animation streamer module 255 determines if there is a conflict between the two command tracks or between one command track and a current state of robot 100, as described with reference to block 320 above.

If there is no conflict, at block 415, animation streamer module 255 executes the command tracks. If there is a conflict, at block 420, animation streamer module 255 determines the relative priority values of the conflict, e.g., as described with reference to block 330 above. At block 425, similar to block 335 above, animation streamer module 255 disregards or otherwise omits the command track or state having a lower priority value and method 400 proceeds to block 415 to execute any other command tracks.

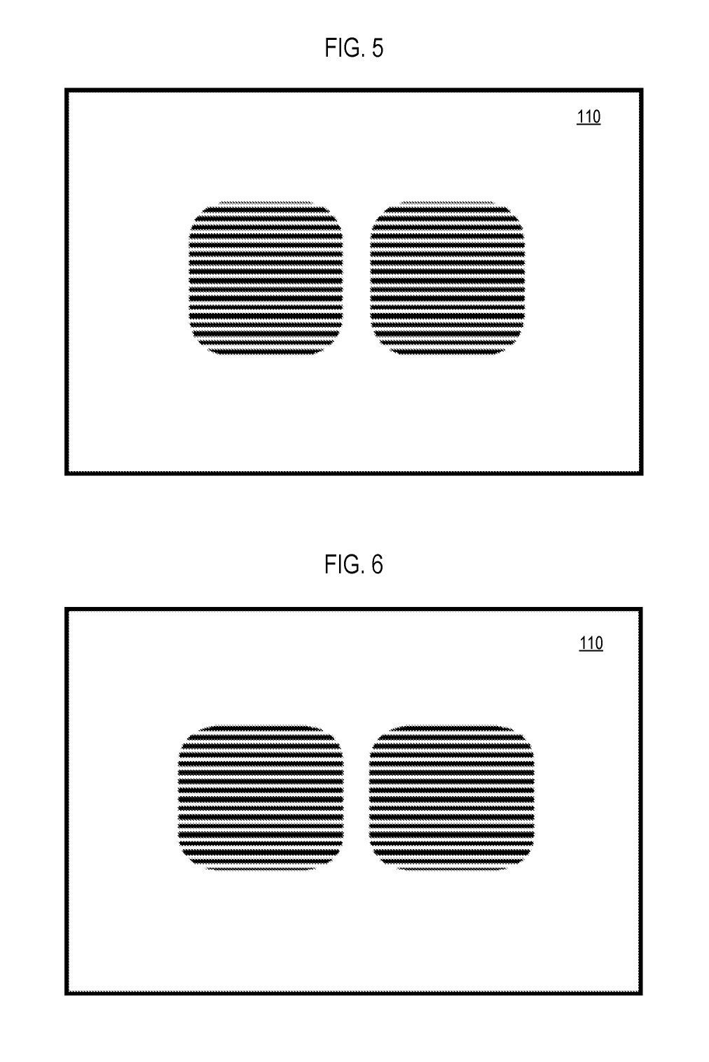

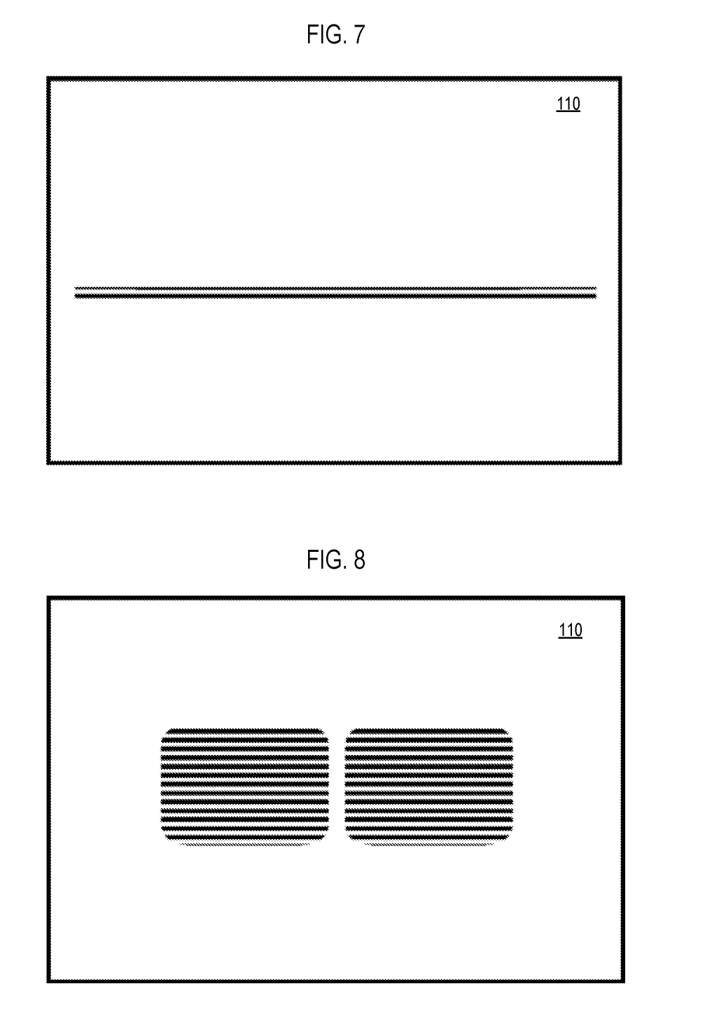

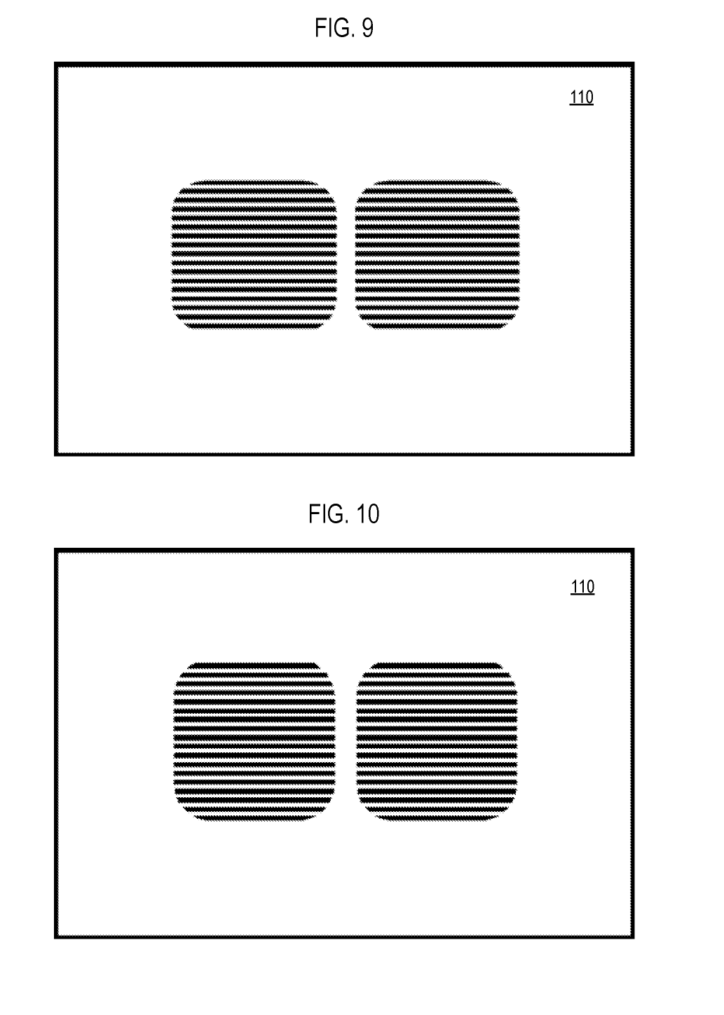

FIGS. 5-10 illustrate an exemplary sequence of frames to animate a display object using an animation command track. In particular, the exemplary sequence of frames is an animation including display objects representing two stylized eyes on electronic display 110. In this illustrated sequence of frames, the command tracks execute a blink effect, as shown in FIG. 7. For example, FIG. 5 illustrates two sets of illuminated lines alternating with non-illuminated lines to form left and right eyes, depicting two eyes in a wide-open state to the viewer. FIG. 6 illustrates a change in shape of the display objects by altering the number and/or length of the illuminated lines (or otherwise changing the number and/or size of the sets of illuminated pixels). This change in shape of the display objects presents to the viewer the pair of eyes as narrowing or otherwise beginning to close. FIG. 7 illustrates further change in shape of the display objects by altering the number and/or length of the illuminated lines. This change in shape of the display objects presents to the viewer the pair of eyes as closed mid-blink. FIG. 8 illustrates further change in shape of the display objects by altering the number and/or length of the illuminated lines. This change in shape of the display objects presents to the viewer the pair of eyes as opening following the blink. The change in shape of the display objects continues by altering the number and/or length of the illuminated lines in FIGS. 9-10. This change in shape of the display objects presents to the viewer the pair of eyes as opening further following the blink and returning to a wide-open state.

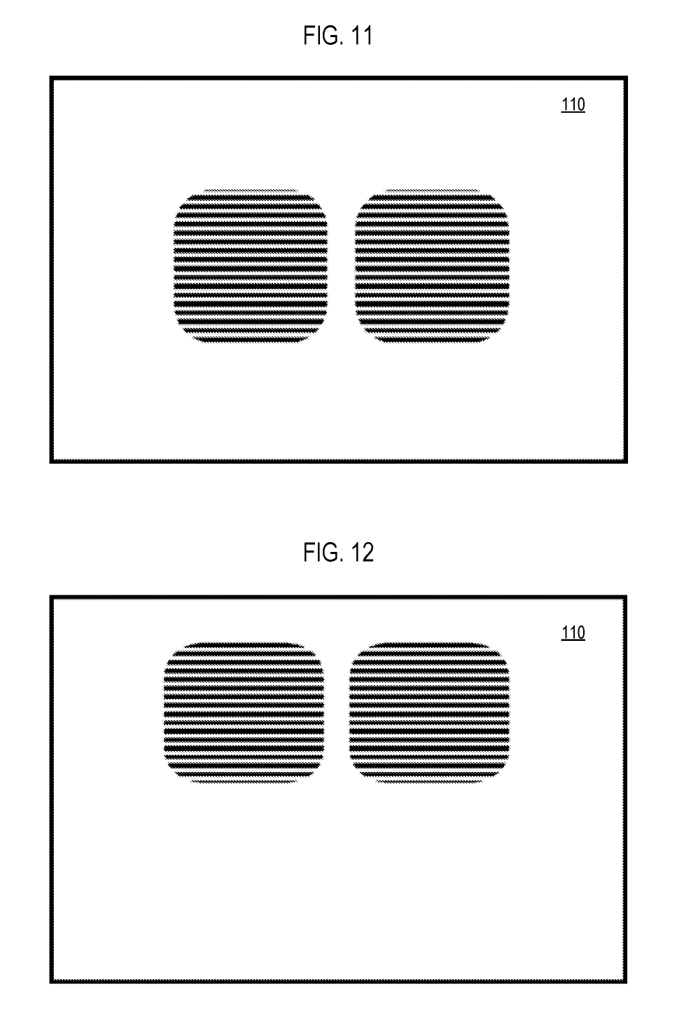

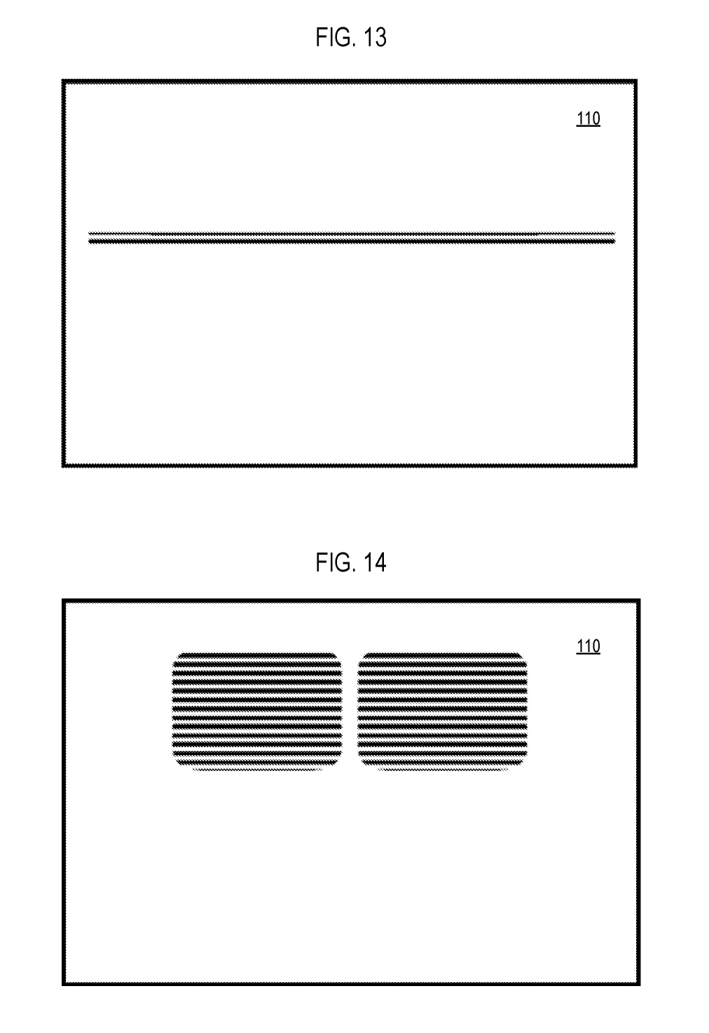

FIGS. 11-14 illustrate an exemplary sequence of frames to animate a display object using a composite animation command track. For example, one set of command tracks may include a command track to dart or otherwise move eyes upward and another set of command tracks may include a command track to execute a blink. The composite command track includes both command tracks as different layers of control of eyes on display 110. As a result, FIGS. 11-12 illustrate eyes moving upward, FIG. 13 illustrates a blink with eyes moved upward, and FIG. 14 illustrates maintaining eyes upward while opening post-blink.

FIG. 15 illustrates an exemplary interactive cube that may trigger one or more animation control commands. While illustrated as a cube, interactive objects may be in other forms. Interactive cube 1500 includes pattern 1505 and lights 1510 on multiple edges. In one embodiment, interactive cube 1500 includes one or more internal components (not illustrated) to control interactive cube 1500 and/or communicate with robot 100. For example, interactive cube 1500 may include one or more processing units, NIC(s), and/or sensors to detect vibration or motion. An animation or command track may be triggered by recognition of pattern 1505 using camera 115, robot 100 receiving a communication from interactive cube 1500 of one or more lights 1510 being activated, and/or interactive cube 1500 sensing a user tapping or otherwise physically interacting with interactive cube 1500. In one embodiment, a command track causes robot 100 to control an aspect of interactive cube 1500. For example, an executed command track may cause robot 100 to control lights 1510.

While this document illustrates and describes embodiments implemented using software modules, alternate embodiments of the invention may be implemented in, but not limited to, hardware or firmware utilizing an FPGA, ASIC, and/or processing unit(s) 205 and/or 245. Modules and apparatus of hardware or software implementations can be divided or combined without significantly altering embodiments of the invention. One or more buses interconnect components of robot 100 and/or user device 200. Fewer or more buses than illustrated may interconnect the components. In one embodiment, one or more components may connect to one another wirelessly.

It will be apparent from this description that aspects of the inventions may be embodied, at least in part, in software. That is, computer-implemented methods 300 and 400 may be carried out in one or more computer systems or other data processing systems, such as robot 100 and/or user device 200, in response to its processor executing sequences of instructions contained in a memory or another non-transitory machine-readable storage medium. The software may further be transmitted or received over a wired or wireless connection via a network interface. In various embodiments, hardwired circuitry may be used in combination with the software instructions to implement the present embodiments. Thus, the techniques are not limited to any specific combination of hardware circuitry and software, or to any particular source for the instructions executed by a node and/or central controller. It will also be appreciated that additional components, not shown, may also be part of robot 100 and/or user device 200, and, in certain embodiments, fewer components than that shown in FIG. 2 may also be used in system robot 100 and/or user device 200.

In the foregoing specification, the invention(s) have been described with reference to specific exemplary embodiments thereof. Various embodiments and aspects of the invention(s) are described with reference to details discussed in this document, and the accompanying drawings illustrate the various embodiments. The description above and drawings are illustrative of the invention and are not to be construed as limiting the invention. References in the specification to “one embodiment,” “an embodiment,” “an exemplary embodiment,” etc., indicate that the embodiment described may include a particular feature, structure, or characteristic, but not every embodiment may necessarily include the particular feature, structure, or characteristic. Moreover, such phrases are not necessarily referring to the same embodiment. Furthermore, when a particular feature, structure, or characteristic is described in connection with an embodiment, such feature, structure, or characteristic may be implemented in connection with other embodiments whether or not explicitly described. Additionally, as used in this document, the term “exemplary” refers to embodiments that serve as simply an example or illustration. The use of exemplary should not be construed as an indication of preferred examples. Blocks with dashed borders (e.g., large dashes, small dashes, dot-dash, dots) are used to illustrate virtualized resources or, in flow charts, optional operations that add additional features to embodiments of the invention. However, such notation should not be taken to mean that these are the only options or optional operations, and/or that blocks with solid borders are not optional in certain embodiments of the invention. Numerous specific details are described to provide a thorough understanding of various embodiments of the present invention. However, in certain instances, well-known or conventional details are not described in order to provide a concise discussion of embodiments of the present inventions.

Embodiments according to the invention are, in particular, disclosed in the claims directed to a method, a storage medium, and a system, wherein any feature mentioned in one claim category, e.g., the system, can be claimed in another claim category, e.g., the method, as well. The dependencies or references in the claims are chosen for formal reasons only. Any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

It will be evident that various modifications may be made thereto without departing from the broader spirit and scope of the invention as set forth in the following claims. For example, the methods described in this document may be performed with fewer or more features/blocks or the features/blocks may be performed in differing orders. Additionally, the methods described in this document may be repeated or performed in parallel with one another or in parallel with different instances of the same or similar methods.

What is claimed is:

1. A computer-implemented method comprising:
receiving a first set of one or more command tracks, each command track directed to control a different component of a robot than other command tracks within the first set;
receiving a second set of one or more command tracks, each command track directed to control a different component of the robot than other command tracks within the second set;
detecting that a first command track within the first set is directed to control a first component of the robot to perform a first action and a second command track within the second set is directed to control the first component of the robot to perform a second action;
in response to detecting that both the first and second command tracks are directed to control the first component of the robot, merging the first and second command tracks into a composite command track; and
executing the composite command track, wherein the execution of the composite command track causes the first component of the robot to perform the first action while performing the second action.

2. The computer-implemented method of claim 1, wherein the merging of the first and second command tracks is further in response to determining that the first and second actions are not in conflict with one another.

3. The computer-implemented method of claim 2, wherein determining that the first and second actions are not in conflict with one another includes detecting that the first command track controls a first layer of the first component and the second command track controls a second layer of the first component.

4. The computer-implemented method of claim 1, wherein the composite command track is executed during the execution of one or more other command tracks from the first and/or second sets of command tracks.

5. The computer-implemented method of claim 4, wherein the executed command tracks include an audio command track, and wherein timing of execution of another track within the executed command tracks is controlled by the audio command track.

6. The computer-implemented method of claim 1, wherein the first component of the robot is a head, a wheel, an electronic display, an arm, a speaker, or a light.

7. The computer-implemented method of claim 1, wherein the first action is a physical movement of a component of the robot, an audible output by a speaker on the robot, or an output of an object on an electronic of the robot.

8. The computer-implemented method of claim 1, the method further comprising:
detecting that a third command track within the first set is directed to control a second component of the robot to perform a third action;
determining that the third action is in conflict with a first current state of the robot or with a fourth command track within the second set, the fourth command track being directed to a fourth action; and
in response to the determined conflict, omitting the third command track from execution during execution of command tracks from the first and/or second sets of command tracks.

9. The computer-implemented method of claim 8, the method further comprising:
determining that the third action has a lower priority than that of the first current state or the fourth action, wherein the omission of the third command track is further in response to the determined lower priority.

10. The computer-implemented method of claim 9, wherein priority of actions is dynamically dependent upon a second current state of the robot.

11. The computer-implemented method of claim 10, wherein the second current state is a simulated mood of the robot.

12. The computer-implemented method of claim 1, wherein the first set includes a plurality of command tracks received as a message from a user device, the user device transmitting the message in response to an application on the user device translating one or more programming language elements into the message.

13. The computer-implemented method of claim 12, wherein the one or more programming language elements are a set of one or more blocks of a visual programming language.

14. The computer-implemented method of claim 12, wherein the application on the user device is a software development kit.

15. A non-transitory computer-readable medium storing instructions, which when executed by a processing device, cause the processing device to perform a method comprising:
receiving a first set of one or more command tracks, each command track directed to control a different component of a robot than other command tracks within the first set;
receiving a second set of one or more command tracks, each command track directed to control a different component of the robot than other command tracks within the second set;
detecting that a first command track within the first set is directed to control a first component of the robot to perform a first action and a second command track within the second set is directed to control the first component of the robot to perform a second action;
in response to detecting that both the first and second command tracks are directed to control the first component of the robot, merging the first and second command tracks into a composite command track; and
executing the composite command track, wherein the execution of the composite command track causes the first component of the robot to perform the first action while performing the second action.

16. The non-transitory computer-readable medium of claim 15, wherein the merging of the first and second command tracks is further in response to determining that the first and second actions are not in conflict with one another.

17. The non-transitory computer-readable medium of claim 16, wherein determining that the first and second actions are not in conflict with one another includes detecting that the first command track controls a first layer of the first component and the second command track controls a second layer of the first component.

18. The non-transitory computer-readable medium of claim 15, the method further comprising:
detecting that a third command track within the first set is directed to control a second component of the robot to perform a third action;
determining that the third action is in conflict with a first current state of the robot or with a fourth command track within the second set, the fourth command track being directed to a fourth action; and
in response to the determined conflict, omitting the third command track from execution during execution of command tracks from the first and/or second sets of command tracks.

19. The non-transitory computer-readable medium of claim 18, the method further comprising:
determining that the third action has a lower priority than that of the first current state or the fourth action, wherein the omission of the third command track is further in response to the determined lower priority.

20. A system comprising:
a memory storing instructions; and
a processor coupled to the memory, wherein the processor executes the instructions, causing the system to:
receive a first set of one or more command tracks, each command track directed to control a different component of a robot than other command tracks within the first set;
receive a second set of one or more command tracks, each command track directed to control a different component of the robot than other command tracks within the second set;
detect that a first command track within the first set is directed to control a first component of the robot to perform a first action and a second command track within the second set is directed to control the first component of the robot to perform a second action;
in response to detecting that both the first and second command tracks are directed to control the first component of the robot, merge the first and second command tracks into a composite command track; and
execute the composite command track, wherein the execution of the composite command track causes the first component of the robot to perform the first action while performing the second action.
